(19) United States
(12) Patent Application Publication
(10) Pub. No.: US 2003/0042997 A1
(43) Pub. Date: Mar. 6, 2003

(54) Tunable microwave systems with air-dielectric sandwich structures

(75) Inventors: Sunggi Baik, Pohang-shi (KR); Minki Jeong, Pohang-shi (KR); Beomjin Kim, Pohang-shi (KR); Yuriy Poplavko, Pohang-shi (KR); Yuriy Prokopenko, Pohang-shi (KR)

Correspondence Address: BACON & THOMAS, PLLC, 625 SLATERS LANE, FOURTH FLOOR, ALEXANDRIA, VA, 22314

(73) Assignee: POSTECH FOUNDATION, Kyungsangbuk-do (KR)

(21) Appl. No.: 10/083,309

(22) Filed: Feb. 27, 2002

(30) Foreign Application Priority Data
Aug. 22, 2001 (KR) 2001-50515

(51) Int. Cl. H01P 1/18

(52) U.S. Cl. 333/156

(57) ABSTRACT

Air-dielectric sandwich structures for electrically tunable microwave devices provide two types of layered structures; one type comprising a first dielectric material, a second dielectric material, an air gap between the first and second dielectric materials and an electromechanical actuator for adjusting the width of the air gap by moving the first or second dielectric materials, and the other type comprising a dielectric material, a metal wall, an air gap between the dielectric material and the metal wall and an actuator for adjusting the width of the air gap by moving the dielectric material or the metal wall. The tunable microwave devices including the air-dielectric sandwich structure are elaborated such as a tunable dielectric resonator, a band stop and a band pass filter, a phase shifter and a phase array antenna.

### FIELD OF THE INVENTION

The present invention relates to electrically tunable microwave dielectric components and devices; and, more particularly, to frequency agile dielectric resonators for tunable oscillators/filters and phase shifters for phased array antenna in microwave and millimeter-wave for the frequency range of 0.3-100 GHz.

### DESCRIPTION OF THE PRIOR ART

Tunable microwave devices are in greater demand for further development of modern telecommunication systems. Microwave oscillators and filters which form the essential components in microwave communication devices use their resonance frequencies to control the behaviors of microwave signals. The ability of tuning resonance frequency can broaden the application range of microwave devices. Another important microwave device for telecommunication, phased array antenna, needs tunable phase shifters, which can provide fast and accurate steering of electromagnetic waves. All the tunable microwave devices should guarantee high speed of tuning and compact size suitable for modern telecommunication applications. Prior arts of tunable dielectric resonators and phase shifters are described hereinafter.

The dielectric resonators usually place dielectric materials inside metal cavities, in which several dominant modes appear to provide the resonance frequencies. The microwave filters and the oscillators include the dielectric resonators which are properly shaped and arranged for desired properties. The dielectric materials should have high dielectric constants to minimize the size of the device. Thermal stability or low temperature coefficient of dielectric properties is also a critical requirement to achieve the reliability of the devices and the good selectivity of the devices. Modern telecommunication requires a large number of the resonance frequencies in a system, which results in a band of the resonance frequencies. Therefore, there has been much effort to develop the tunable dielectric resonator in which the resonance frequencies can be selected readily for any desired purposes.

The resonance frequencies of the dielectric resonators can be tuned in several different ways. One method involves adjusting the volume of the metal cavity or an enclosure of a resonator by moving plates or screws. The second method is changing the volume of the dielectric materials, which can be achieved, for example, by adjusting the space between two dielectric resonators or moving the cylindrical dielectric body inside the hollow metal cavity. The third method is varying the relative position of the dielectric materials inside the metal cavity. However, the tunable dielectric resonators described above have problems caused by using slow mechanical movements of the plates, screws, or dielectric bodies. These result in frictions and low operation speed, which are disadvantageous for use in modern telecommunication systems which require very fast response time. Tuning methods presented so far and their characteristics are described in more detail in U.S. Pat. No. 5,691,677 and the references cited therein.

The phased array antenna provides fast steering of electromagnetic wave signals. The phase shifters are arranged regularly in the antennas to provide relative phase change in transmitting signals. As a consequence of the superposition of all the transmitting waves, the phase shifters array can radiate electromagnetic wave pointing purposely to certain directions.

One type of commercially available phase shifters is made of ferrite. As a bias of magnetic field is applied to the ferrite, magnetic susceptibility is changed, which leads to the change in the propagation constant of microwave signals, thus a phase shift. The ferrite phase shifters, however, need quite large magnetic field, large size and high cost. Thin ferrite phase shifters are still disadvantageous due to its non-linearity at high power applications.

PIN diode phase shifters are advantageous for its small size and high speed in comparison with the ferrite phase shifters. However, insertion loss for the diode phase shifters is greater than that for the ferrite phase shifters.

Recently, ferroelectric phase shifters have been widely investigated, especially in thin film form. As a bias of electric field is applied to a ferroelectric material, its dielectric constant is changed. Dielectric constant of such a ferroelectric material decreases as an applied electric field increases. Thus, by controlling voltages applied to the ferroelectric material, the ferroelectric phase shifters can provide desired amount of phase shift. However, large electric field has to be applied to the ferroelectric material in order to obtain the phase shift reasonable for practical applications. Moreover, relatively high dielectric loss of the ferroelectric materials prevents it from being utilized for wide device applications.

Another type of the phase shifters combines active and ground planes of transmission line with dielectric slabs movable therebetween, as described in U.S. Pat. No. 6,075,424. It is advantageous in providing impedance matching by appropriately designing the shapes and dimensions of the dielectric slabs or the transmission line. However the phase shifter described above does not provide the adequate methods to control the movement of the dielectric slabs effectively. This device also seems to be massive in its original configuration and not suitable for application to compact-sized phased array antennas.

### SUMMARY OF THE INVENTION

It is, therefore, an object of the present invention to provide an air-dielectric sandwich structure for controlling resonance frequencies, a band of the resonance frequencies and relative phase of the transmitting microwave.

In accordance with a first preferred embodiment of the present invention, there is provided an air-dielectric sandwich structure for tunable microwave device comprising: a first dielectric material; a second dielectric material; an air gap between the first and second dielectric materials; and an electromechanical actuator for adjusting the width of the air gap by moving the first or second dielectric materials.

In accordance with a second preferred embodiment of the present invention, there is provided an air-dielectric sandwich structure for tunable microwave device comprising: a dielectric material; a metal wall; an air gap between the dielectric material and the metal wall; and an actuator for adjusting the width of the air gap by moving the dielectric material or the metal wall.

### BRIEF DESCRIPTION OF THE DRAWINGS

The objects and features of the present invention will become apparent from the following description of preferred embodiments given in conjunction with the accompanying drawings.

FIGS. 1A and 1B show two basic configurations of air-dielectric sandwich structures, respectively, in accordance with the present invention;

FIGS. 2A and 2B show the dielectric characteristics of the air-dielectric sandwich structure, shown in FIG. 1B;

FIG. 3 depicts dielectric characteristics of the air-dielectric sandwich structures shown in FIG. 1B with well known low cost microwave dielectric materials;

FIGS. 4A to 4D show schematic drawings of usual dielectric resonators (DR) and FIGS. 4E to 4H show dielectric resonators with air-dielectric sandwich structures;

FIG. 5 shows a possible realization of tunable dielectric resonator with a half ring type air-dielectric sandwich structure;

FIG. 6 demonstrates the changes in the resonance frequencies for the ring DR and the disk DR, respectively;

FIGS. 7A to 7C describe a waveguide band-pass filter with two disk type tunable dielectric resonators inside;

FIG. 8A is a band-stop filter with a rectangular air-dielectric sandwich structure in a waveguide. FIG. 8B shows attenuation-frequency characteristics, which demonstrates that the resonance frequency could be adjusted by 12%;

FIG. 9 shows two possible schemes of the phase shifter based on the air-dielectric composite in a waveguide;

FIG. 10 shows phase shift of the phase shifter based on the air-dielectric sandwich structure shown in FIG. 9; and

FIG. 11 shows a two-dimensional lens type phased array antenna built from phase shifters depicted in FIG. 9.

### DETAILED DESCRIPTION OF THE PREFERRED EMBODIMENTS

The present invention provides an air-dielectric sandwich structure for electrically tunable microwave devices. The air-dielectric sandwich structure includes the layered structure of the dielectric materials having a high dielectric constant and an air gap combined with an electromechanical actuator attached to the dielectric material.

Two basic types of layered structures are proposed. One includes layers of two dielectric materials divided by an air gap. The other includes a dielectric layer, a metal wall and an air gap therebetween. Such layered structures hold high quality factor for microwave propagation, since one of their components, the air gap, is practically loss free, and dielectric materials can be selected from those with low loss.

The effective dielectric constant of the sandwich structure can be controlled from adjusting the width of the air gap by using the electromechanical actuator. According to the performance of the actuator, the effective dielectric constant can be tuned with the response time of 10⁻⁵ s. As the dielectric constant is one of the main parameters determining the microwave properties (propagation constant, resonance frequency, etc.), the sandwich structure itself can be considered as a component for tunable microwave device.

The present invention proposes the following two types of microwave devices based on the idea described above. One is the dielectric resonator built with the air-dielectric sandwich structure, in which the resonance frequency is electrically tunable up to 20-25% very rapidly and accurately. This allows us to design fast tunable oscillators and filters with electrically variable resonance frequency. The other is a phase shifter constructed with the air-dielectric sandwich structure placed into a waveguide. Microwave signal transmitted through the phase shifter changes its phase as an actuator changes the width of an air gap, such that the effective dielectric constant of the air-dielectric sandwich structure is changed. By arranging the proposed phase shifters in two-dimensional m×n array, a phase shifting part of the phased array antenna can be constructed. The phase shifter also can be used in a lens-type phased array antenna. In this case, the number of phase shifting elements used therein can be reduced to m+n. One-dimensional lens-type phased array antenna for car collision avoidance radar also can be constructed. All types of phased array antenna containing the proposed phase shifters allow fast and accurate control of steering microwave beam with low loss and low power consumption. Another important advantage of the present invention is the possibility to work in the frequency range over 1 GHz up to 100 GHz. Another very important advantage of the proposed phase shifter is the flexibility in choosing design parameters.

Hereinafter, the embodiments of the present invention will be described in order such as 1) tunable air-dielectric sandwich structure, 2) tunable dielectric resonator, 3) tunable microwave filter, 4) tunable phase shifter and 5) lens-type phased array antenna.

1) Tunable Air-Dielectric Composite Structure

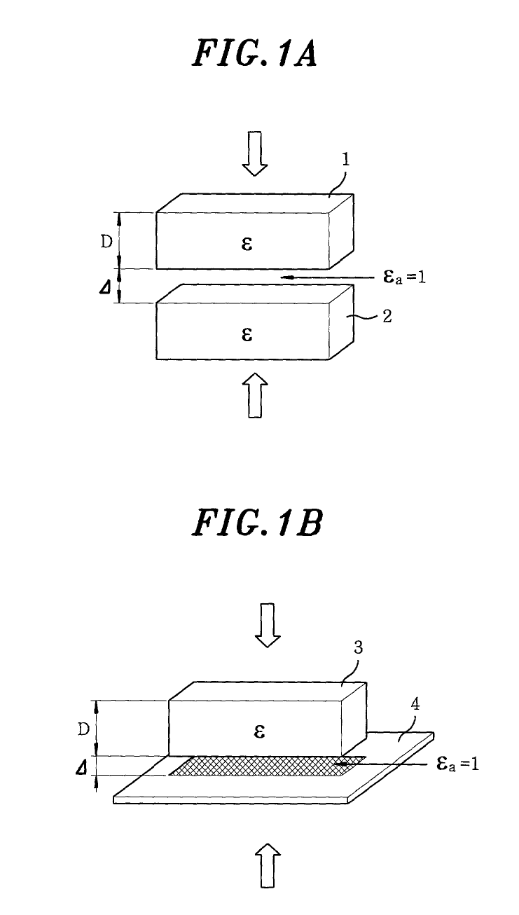

FIG. 1 shows diagrams of an air-dielectric sandwich structure in accordance with the present invention. FIG. 1A shows two dielectric materials 1 and 2 having a predetermined thickness D and an air gap with a width Δ therebetween. FIG. 1B illustrates an air-dielectric sandwich structure, wherein a dielectric material 3 with a predetermined thickness D faces a metal wall 4 while being separated by air gap with a width Δ.

The dielectric materials 1 to 3 have high dielectric constants and low losses. As the ratio Δ/D varies, the effective dielectric constant of the air-dielectric sandwich structure is changed drastically. The effective loss of this layered structure also varies according to the ratio Δ/D.

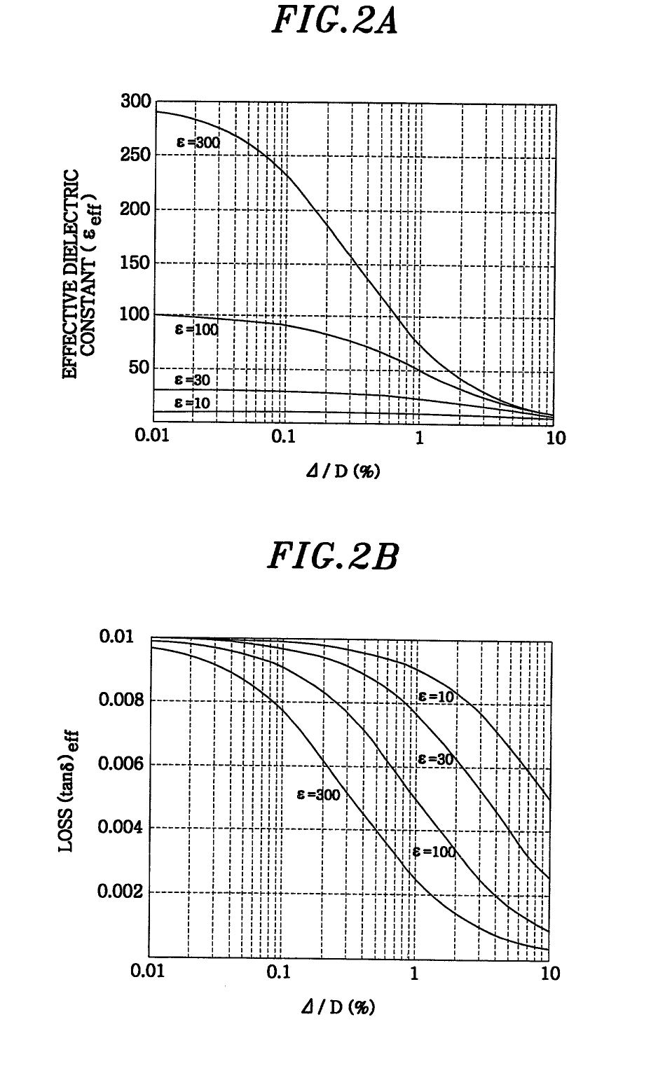

FIGS. 2A and 2B show the changes in the effective dielectric constant and the effective loss of the layered structure according to the varying ratio Δ/D of the structure depicted in FIG. 1B. Several cases with different dielectric materials are examined. FIG. 2A shows the changes in the effective dielectric constants with the varying percentage ratios of the width of air gap Δ with respect to the thickness of dielectric materials D. FIG. 2B shows the changes in the effective dielectric losses with the varying ratios of the width of air gap (tanδ=0) and dielectric material (tanδ=0.01).

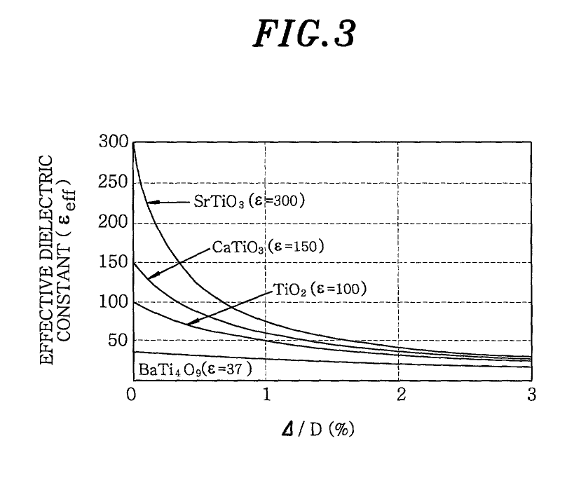

The effective dielectric constants of the layered structure with various dielectric materials are shown in FIG. 3. FIG. 3 depicts dielectric characteristics of the air-dielectric sandwich structures shown in FIG. 1B with well known low cost microwave dielectric materials such as BaTi₄O₉ (ε=37), TiO₂ (ε=100), CaTiO₃ (ε=150), SrTiO₃ (ε=300), and Ba(Sr,Ti)O₃ (ε=1000) . High quality, but more expensive microwave dielectrics, such as (Mg,Ca)TiO₃ (ε=20), Ba(Zr,Zn,Ta)O₃ (ε=30), BLT (ε=80-120), also might be used. As shown in FIG. 3, drastic changes in the effective dielectric constant can be realized by using the material with higher dielectric constant. The calculation is done by assuming a static serial capacitors model.

One of the main objectives of this invention is to present how to control the ratio Δ/D of the layered structure effectively, so that it can be applied to modern tunable microwave devices. There is proposed an electrostrictive/piezoelectric actuator attached to the air-dielectric sandwich structure to achieve this goal. The electrostrictive/piezoelectric actuator can move the dielectric materials or the metal wall vertically to control the air gap. Since commercial actuators can provide the accuracy of a tenth of microns and the response time of several microseconds when using a power supply of equal to or lower than 100 V, very fast and accurate control of the dielectric constant of the layered structure can be realized. Moreover, there are various methods to locate the actuator used in the layered structure. We can, for example, put an actuator beside a metal cavity to move the metal wall relative to the dielectric materials, that is, controlling the width of the air gap. This increases the flexibility in the design of the air-dielectric sandwich structure and various microwave devices adapting the sandwich structure.

One of the most advantageous points of the present invention is that the proposed structure allows great flexibility in the design of the devices. That is, depending on the purposes of the devices, proper dielectric materials, dimension of the sandwich structure, initial size of the air gap, and so on can be determined by a designer. This enables the air-dielectric sandwich structure to be used as a component of various microwave devices with different properties over a wide frequency range.

The effective dielectric constant of the sandwich structure is a critical parameter which determines the microwave properties, such as the propagation constant of the signals or the resonance frequencies. As described above, the effective dielectric constant of the air-dielectric sandwich structure can be controlled with the reasonable accuracy and response time enough to be applied in modern telecommunication systems. Thus, various tunable microwave devices can be constructed based on the proposed air-dielectric sandwich structure. Some of the examples will be described in more detail hereinafter. However, the possible applications of the proposed air-dielectric sandwich structure are not limited to such examples.

2) Tunable Dielectric Resonator

Dielectric resonator is widely used in the microwave devices, for example, to stabilize the frequency of oscillator or as a component of microwave filter. The dielectric resonators are made of microwave ceramics with thermal stability of dielectric constant being 20˜120 and quality factor Q around 10⁴. Stationary resonance frequency is one requirement for microwave ceramics to be applied as a dielectric resonator. Temperature change or mechanical displacement of the dielectric resonator inside a shielding cavity or a waveguide may induce the uncertainty or undesirable deviation in the resonance frequency. Therefore, the resonance frequency should be controlled precisely to be applied in modern microwave devices. As described in the prior art, several candidates have been developed for tunable dielectric resonators, but they have severe drawbacks such as low operation speed and poor tunability. The present invention of dielectric resonators based on the air-dielectric sandwich structure is intended to obtain the high speed and accuracy in controlling the resonance frequencies.

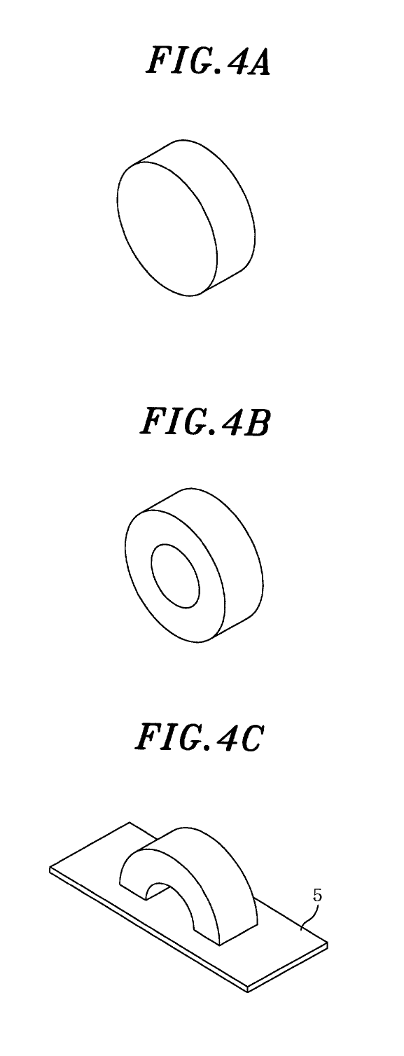

FIGS. 4A to 4H show several possible ways for constructing tunable dielectric resonators with the air-dielectric sandwich structure, where Δ represents the width of an air gap. FIGS. 4A to 4D depict disk type, ring type, a half ring type and a quarter ring type resonator respectively, in which each dielectric material faces a metal wall 5 to reflect microwave images. FIGS. 4E to 4H represent the construction of dielectric resonators with air-dielectric sandwich structures originated from FIGS. 4A to 4D, respectively. The imaging of dielectric resonators is applied to broaden the range of resonance frequency as well as to decrease the size of the devices.

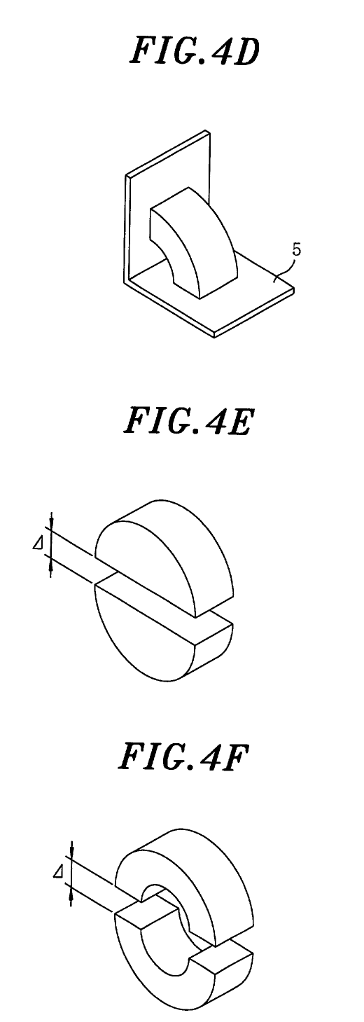

FIG. 5 illustrates a cross-sectional view of a tunable half ring-type resonator using the proposed air-dielectric sandwich structure and an actuator to control the air gap. A multilayer microactuator can easily generate the displacement of 20 μm under a power supply of 100 V such that the resonance frequency can be adjusted by 10% with a proper selection of the dielectric material and its dimensions.

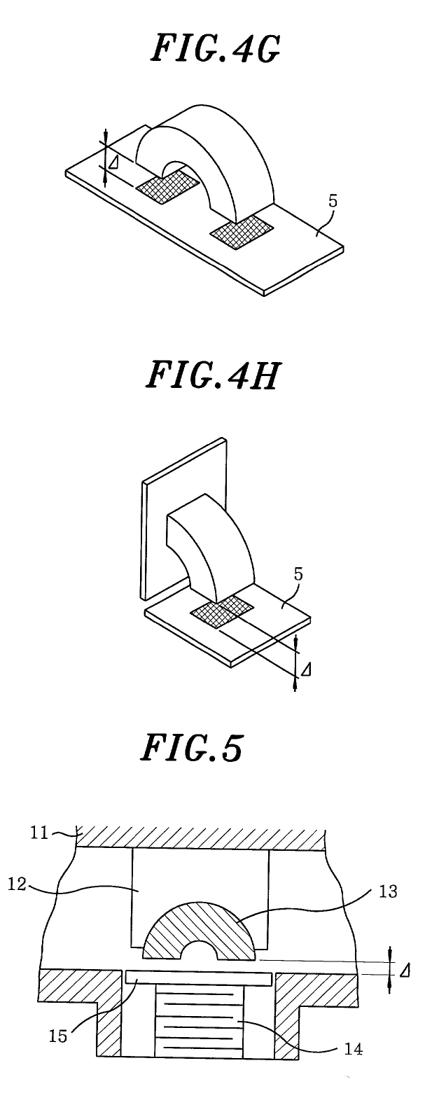

In the following, the design of the dielectric resonator with the air-dielectric sandwich structure is analyzed theoretically to obtain the cardinal parameters and to investigate the optimal components and materials. FIG. 6 illustrates tunability of resonance frequencies using disk-type as well as ring-type dielectric resonators. Experiment was performed at the frequency of 10 GHz. Dimensions of ring and disk DR are specified as the external radius Rₑ=2.6 mm, the internal radius Rᵢ=1.1 mm, and the thickness h =2.1 mm. Using the dielectric material with ε=80, 30˜40% of tunability can be achieved by adjusting the air-gap by more than 100 μm. The dimensions to achieve such characteristics are shown in FIG. 6.

3) Tunable Microwave Filter

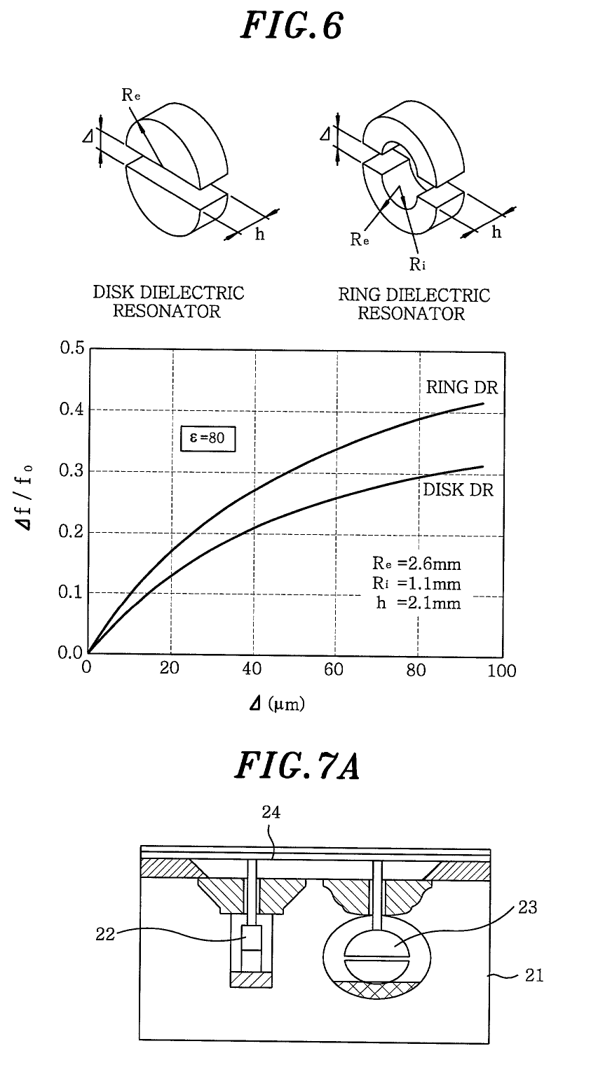

It is also possible to construct tunable microwave filter using the air-dielectric sandwich structures shown in FIG. 4. FIG. 7A shows an example of the bandpass filter made of two dielectric resonators with the air-dielectric sandwich structure and its reflection characteristics. As shown in FIG. 7A, two dielectric resonators 22 and 23 of disk-type include the air-sandwich structure which has two halves of the disk dielectric resonator and an air gap between them. The dimension of the air gap is changed by applying the voltage to the actuator 24 which supports and moves the rod connected to the half of disk.

Dynamic control of the resonance frequency will be described in the following. One dielectric resonator 22 stands for an electrical dipole mode f₁ while the other dielectric resonator 23 represents a magnetic dipole mode f₂. In this case, the modes of both resonators 22 and 23 become independent, which is the reason for the attenuation frequency characteristics with perpendicular orientation being preserved in a wide range of spectrum under synchronous change of f₁ and f₂, as shown in FIG. 7B, where the resonance frequency is changed about 20%. In the case where the frequency of only one of two dielectric resonators 22 and 23 is tuned, the shape of the attenuation frequency characteristics with parallel orientation is changed while the central frequency of the filter is fixed, as shown in FIG. 7C.

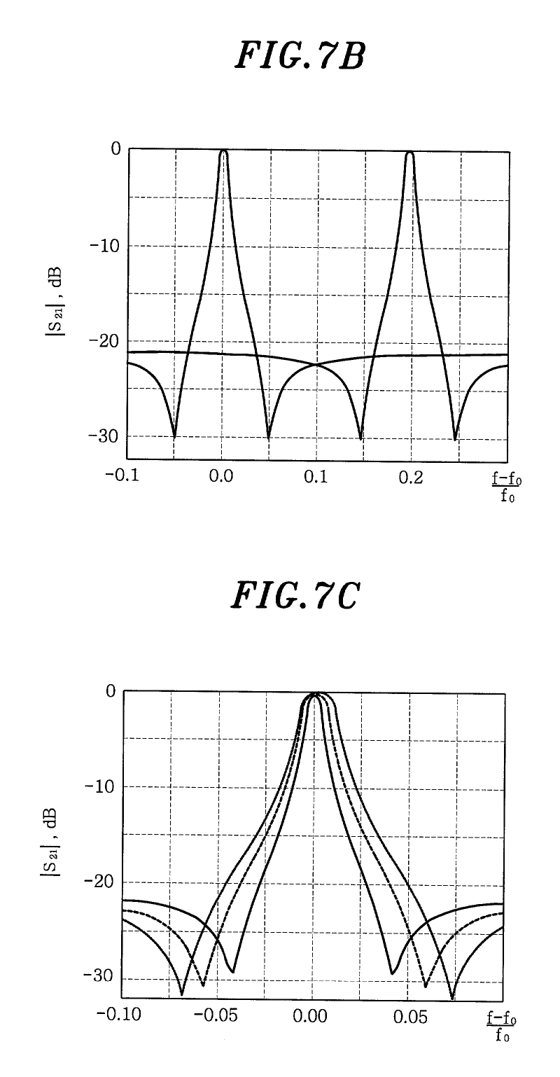

A band stop tunable filter with the air-dielectric sandwich structure is illustrated in FIG. 8A. Experimental results indicate that the resonance frequency is tunable up to 12%, as shown in FIG. 8B, by changing the air gap between two rectangular dielectric slabs 31-1 and 31-2, by using the actuator with a thin path made from fused silica 33 connected to one of the slab. The dielectric slab 31-2 is attached on a low dielectric constant substrate 34.

4) Tunable Phase Shifter

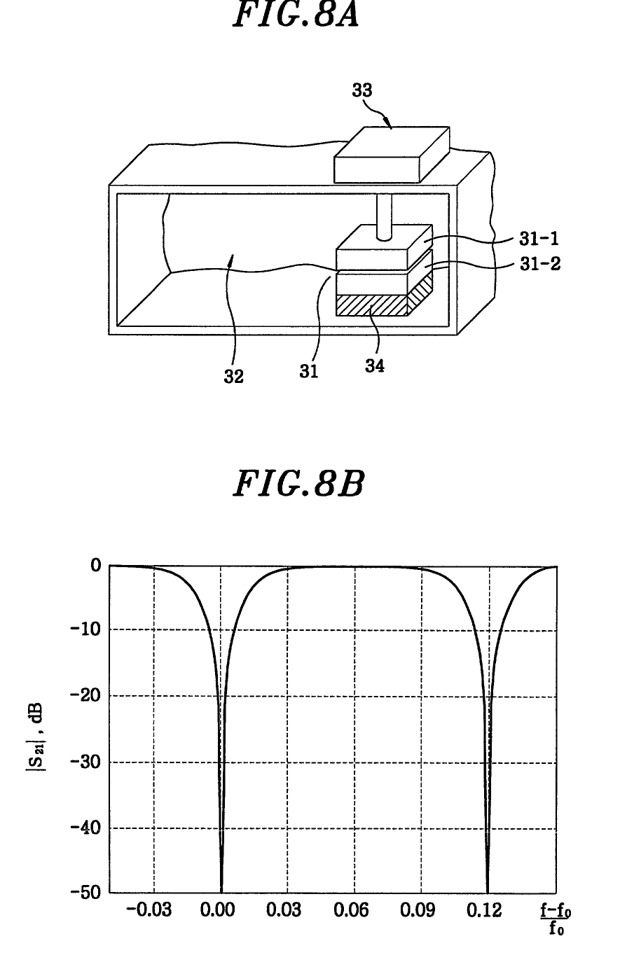

FIG. 9A illustrates a tunable phase shifter constructed based on the air-dielectric sandwich structure, which includes a dielectric material 42, a metal layer 43, an electrostrictive/piezoelectric actuator 44, and an impedance matching block 45 for impedance matching inside a waveguide 41 or a metal cavity. The waveguide 41 plays a role of a transmission line through which microwave or millimeter-wave signals can pass. To induce the phase lag of the signal, the dielectric material 42 is placed inside the waveguide 41 leaving air gap between the top surface of a dielectric material 42 and the inner metal wall of the waveguide 41 as shown in FIG. 9A.

FIG. 9B illustrates another possible configuration in which a metal plate 43 can be moved by an actuator 44, the dielectric material 42 is fixed on an inner wall of the waveguide 41 and an air gap is formed between the metal plate 43 and the dielectric material 42. The electrostrictive/piezoelectric actuator 44 changes the thickness of the air gap between the dielectric material 42 and the metal plate 43 such that the dielectric characteristic of the air-dielectric sandwich structure can be changed. However, to realize the device, it is further needed to attach a matching transformer for reducing reflection loss at each end of the transmission line where signals are transmitted. A matching block 45 provides a way of matching by introducing metal steps beside the air-dielectric sandwich structure. There can be various ways to provide a proper matching using such metal steps and dielectric transformers. According to known methods such as Chebyshev, on condition of a minimum reflection rate allowed, it is possible to achieve an optimized matching by changing the configurations of the matching block, i.e., changing its dimensions, the number of transformers and/or metal steps. A matching method can be chosen depending on requirements of the device, e.g., permissible bandwidth and maximum reflectivity.

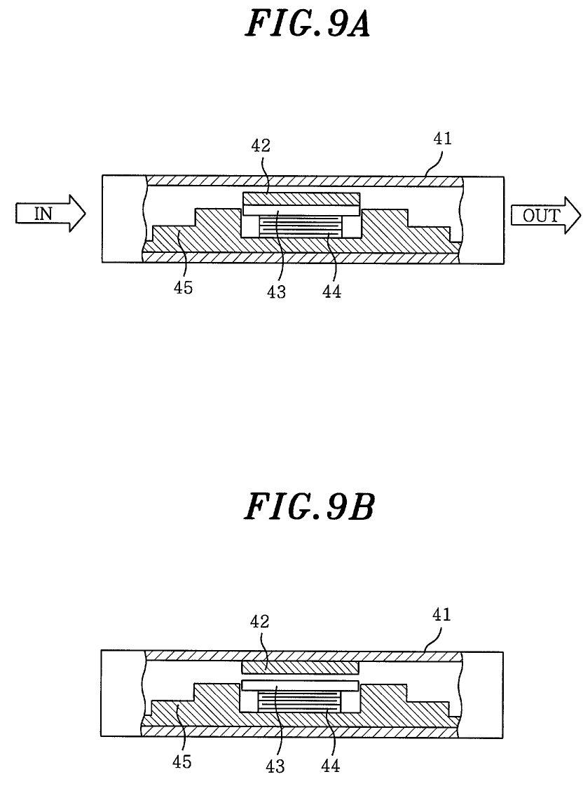

FIG. 10 shows phase delay obtained from the phase shifter constructed based on the air-dielectric sandwich structure shown in FIG. 9. In this experiment, a dielectric material with a dielectric constant of 100 and a loss of tan δ=0.01 was used as a constituent of the air-dielectric sandwich structure to show phase shift at the frequency of 10 GHz. If the thickness D of the dielectric layer is 2 mm and initial air gap is 15 μm, initial effective dielectric constant ε_{eff} becomes 57. In the waveguide including the dielectric material, Equation (1) shows that the wavelength λ is inversely proportional to ε_{eff}^{½},

$$λ = \frac{{λ}_{0}}{\sqrt{{ϵ}_{eff} - {( {λ}_{0} / 2 a )}^{2}}} \qquad Equation ( 1 )$$

where λ₀ is the wavelength of the microwave under vacuum, and a is the width of the cross section of the waveguide. Therefore, according to the above equation, the initial effective dielectric constant of 57 induces the wavelength inside the waveguide to be 5.27 mm at 10 GHz. If we set the length of the air-dielectric structure to be 20 mm, phase delay becomes 1360°. As the air gap is increased up to 45 μm, the effective dielectric constant of the air-dielectric structure becomes 31, which gives the wavelength of 7.14 mm. This corresponds to the phase delay of 1000°. As a result, the phase shift of 360°(2π radians) is induced. An important point is that the phase shift is obtained while preserving high quality factor. If, for example, barium lanthanide titanate(BLT) with a dielectric constant of 100 and a loss of tanδ of 0.002 is used, the insertion loss is only 0.15 dB for phase shift of 2π.

The primary advantage of this invention is that the phase shifter can operate at much higher frequency range, for example, above 40 GHz up to as high as 100 GHz where no electrically controllable phase shifters have been demonstrated up to now. Even for millimeter-wave, phase shifters based on the air-dielectric sandwich structure keep its insertion loss in a manageable range while other phase shifters produce severe loss.

5) Electrically Scanning Lens-Type Phased Array Antenna

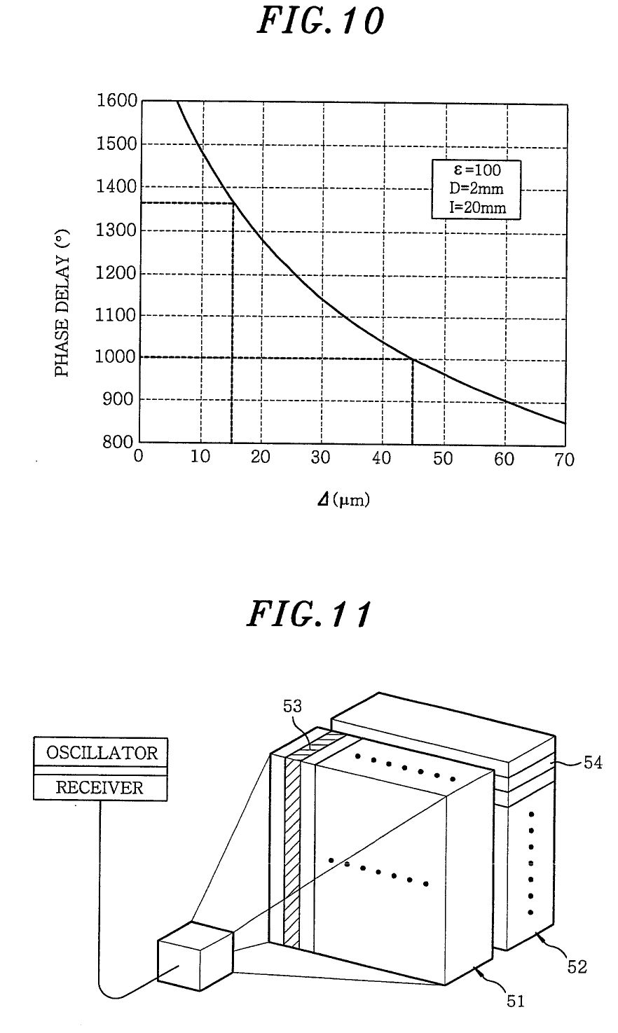

The phase shifters illustrated in FIGS. 9A and 9B can be used in implementing a phased array antenna. We recommend herein the development of a lens-type phased array antenna, as described in U.S. Pat. No. 5,729,239, to utilize the present invention. The application of the phase shifter to the lens-type antenna is illustrated in FIG. 11. Lens antenna based on a phase shifter having the air-dielectric sandwich structure can work at the frequency up to 100 GHz. No other tunable microwave components operating at the millimeter wavelength range has been reported. FIG. 11 shows the principle design of two-dimensional lens antenna, constructed with m+n units of the phase shifters illustrated in FIG. 9. A first antenna array 51 comprising m units of the phase shifters 53 steers the microwave beam horizontally by applying different voltage to each of the phase shifters 53, while a second antenna array 52 comprising n units of the phase shifters 54 steers the beam vertically. Therefore, the lens antenna shown in FIG. 11 can steer the microwave beam in two-dimensional direction by using the first antenna array 51 and the second antenna array 52. Advantages of this type of antenna in comparison with an antenna described in U.S. Pat. No. 5,729,239 are: (1) the required electric potentials are much lower to operate the antenna, (2) the dielectric losses are much lower even at the frequency range beyond 40 GHz, even up to 100 GHz.

In the above-mentioned embodiments, the air-dielectric sandwich structure, i.e., the layered structures of the dielectric material and the air gap are combined with the actuator which moves the dielectric body or the metal wall to adjust the width of the air gap. As the width of the air gap varies, the effective dielectric constants of the air-dielectric sandwich structures are changed. The effective dielectric constants can be controlled in a very accurate and fast way since the commercial electromechanical actuator provides the response time of several microseconds with the applied voltage less than 100 V with the accuracy of a tenth of micrometers. Various air-dielectric sandwich structures can be applied in implementing devices for use in the microwave and millimeter-wave telecommunication.

While the present invention has been described with respect to the particular embodiments, it will be apparent to those skilled in the art that various changes and modifications may be made without departing from the spirit and scope of the invention as defined in the following claims.

What is claimed is:

1. An air-dielectric sandwich structure for tunable microwave device comprising:
a first dielectric material;
a second dielectric material;
an air gap between the first and second dielectric materials; and
an electromechanical actuator for adjusting the width of the air gap by moving the first or second dielectric material.

2. The structure of claim 1, wherein the first and second dielectric materials have shapes of half disk, each of which is separated from each other by the air gap.

3. The structure of claim 1, wherein the first and second dielectric materials have shapes of half ring, each of which is separated from each other by the air gap.

4. The structure of claim 1, wherein the first and second dielectric materials have rectangular shapes, each of which is separated from each other by the air gap.

5. An air-dielectric sandwich structure for tunable microwave device comprising:
a dielectric material;
a metal wall;
an air gap between the dielectric material and the metal wall; and
an actuator for adjusting the width of the air gap by moving the dielectric material or the metal wall.

6. The structure of claim 5, wherein the dielectric material has a shape of disk.

7. The structure of claim 5, wherein the dielectric material has a shape of half ring.

8. The structure of claim 5, wherein the dielectric material has a shape of quarter ring.

9. The structure of claim 5, wherein the dielectric material has a rectangular shape.

10. A tunable microwave device having the air-dielectric sandwich structure of claim 1.

11. The device of claim 10, wherein the device is an electrically tunable microwave resonator.

12. The device of claim 10, wherein the device is an electrically tunable microwave band pass filter.

13. The device of claim 10, wherein the device is an electrically tunable microwave band stop filter.

14. A tunable microwave device including the air-dielectric sandwich structure of claim 4.

15. The device of claim 14, wherein the device is an electrically tunable dielectric resonator.

16. The device of claim 14, wherein the device is a tunable electrostrictive/piezoelectric phase shifter.

17. The device of claim 14, wherein the device is a two-dimensional lens-type phased array antenna containing m+n units of the phase shifters for steering microwave beam horizontally and vertically.
